(19) United States
(12) Patent Application Publication
(10) Pub. No.: US 2025/0306919 A1
(43) Pub. Date: Oct. 2, 2025

(54) AUTOMATION TOOL FOR MANAGING RESOURCES ACROSS COMPUTING ENVIRONMENTS

(71) Applicant: INTUIT INC., Mountain View, CA (US)

(72) Inventors: Curtis BADKE, Sherwood Park (CA); Samuel NESBITT, Sherwood Park (CA)

(21) Appl. No.: 18/622,484

(22) Filed: Mar. 29, 2024

(51) Int. Cl. G06F 8/76; G06F 8/38; G06F 9/451

(52) U.S. Cl. CPC G06F 8/76; G06F 8/38; G06F 9/451

(57) ABSTRACT

Aspects of the present disclosure relate to generating custom user interfaces. Embodiments include providing, via a first computing environment, a configuration component to a builder component, wherein the configuration component comprises: an indication of data to be included in a user interface associated with a second computing environment; a specified format for displaying the data; and a specified schedule for updating the user interface with additional data. Embodiments further include building a user interface comprising the indicated data according to the specified format. Embodiments further include updating the user interface with the additional data to produce an updated user interface. Embodiments further include displaying the updated user interface via a display associated with a computing device.

### INTRODUCTION

Aspects of the present disclosure relate to techniques for generating custom user interfaces. In particular, techniques described herein involve using a builder component to specify, via a first computing environment, a configuration for a user interface associated with a second computing environment. The configuration may specify data from the second environment to be included within the user interface, as well as a format for displaying the data and a schedule for updating the user interface.

### BACKGROUND

Every year, millions of people, businesses, and organizations around the world utilize user interfaces to perform various tasks related to computing. For example, user interfaces may allow users to visualize and perform tasks with data that the users queried from a data source.

Users who perform tasks with data may find it advantageous to do so within a particular computing environment. For example, the particular computing environment may be more efficient than alternative computing environments in performing particular tasks. The particular computing environment may possess user interface features that other computing environments lack. The particular computing environment may also be convenient for the user. For instance, the particular computing environment may be a virtual workspace in which the user performs an assortment of tasks related to a project, and the user may collaborate with other users working within the same computing environment. However, it may be advantageous to use different computing environment for performing other tasks. As an example, a user may perform tasks related to a project within a first computing environment, and data related to completing the project may be located within a second computing environment that is not compatible with the first computing environment. Because the user performs project-related tasks within the first environment, the first environment may be well-suited for allowing the user to enter configurations for displaying data. The second computing environment, which contains the data, may be particularly well-suited for displaying the data. However, in instances where the first computing environment is not natively compatible with the second computing environment, users may be unable to expose a user interface in the second computing environment via the first computing environment. Existing technologies do not allow for user interface interoperability between two otherwise incompatible computing environments. Thus, in many instances, users have no choice but to abandon their preferred computing environments and preferred user interface configurations when performing tasks in a given computing environment involving data held within a different computing environment. Foregoing use of a preferred computing environment may result in wasted computing resources, as the preferred computing environment may be more efficient than other computing environments. Additionally, by not using their preferred computing environment and corresponding user interface, users may sacrifice convenience and lose access to features of the preferred computing environment and corresponding user interface.

Thus, there is a need in the art for improved techniques of enabling interoperability between computing environments.

### BRIEF SUMMARY

Certain embodiments provide a method of generating custom user interfaces. The method generally includes: providing, via a first computing environment, a configuration component to a builder component, wherein the configuration component comprises: an indication of data to be included in a user interface associated with a second computing environment; a specified format for displaying the data; and a specified schedule for updating the user interface with additional data; building, via the builder component, a user interface comprising the indicated data according to the specified format; updating, via the builder component, the user interface with the additional data to produce an updated user interface; and displaying the updated user interface via a display associated with a computing device.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to generating custom user interfaces.

FIG. 2 depicts an additional example of computing components related to generating custom user interfaces.

FIG. 3 depicts example operations related to generating custom user interfaces.

FIG. 4 depicts an example of a processing system for generating custom user interfaces.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating custom user interfaces that enable interoperability between computing environments.

According to certain embodiments, a builder component is configured to serve as an interoperability interface between a first computing environment and a second computing environment that are not natively compatible with one another. For example, a user of the first computing environment (which may provide certain benefits regarding performing tasks as compared to other computing environments) may send configuration information to the builder component specifying data from the second computing environment (which may provide certain benefits regarding displaying and/or storing data as compared to other computing environments) that the user wishes to access and, in some embodiments, parameters relating to the manner and/or format in which the user wishes to receive and/or view the requested data. The builder component may be configured to build and deliver user interface content comprising the requested data in a requested manner and/or format to a user interface in the second computing environment. Thus, techniques described herein enable entering a configuration specification via a first computing environment and seamlessly creating a user interface within the second computing environment based on the configuration specification. Thus, users may utilize the functionality, efficiency, security, and/or other benefits of the first computing environment and the second computing environment.

The first computing environment may be a computing environment corresponding to a software application used by the user. The first computing environment may allow users to use particular user interface features that are specific to the first computing environment, such as specific layouts and tables. The first computing environment may be configured to allow multiple users, such as multiple members of the same organization, to collaborate with one another to complete tasks within the user environment. The first computing environment may also be configured with security measures, such as security measures to prevent unauthorized access to data stored within the computing environment, as well as work product related to the data. For example, work product related to data stored within the first computing environment may include specific selections, arrangements, and combinations of data made by users.

In some embodiments, the user may provide a configuration component to the builder component via the first computing environment. The configuration component may comprise a template for specifying features such as data from a second computing environment to be included within a table, a format for displaying the data, and/or a schedule for updating the user interface with additional data. The configuration component may comprise an indication of data to be included within the user interface. The indication may be based on data that the user wants to include. For example, a user may populate a configuration component template with a label or other descriptor that indicates to the builder component where the desired data is located. Based on this indication, the builder component may include the data from the second computing environment in generated user interface content such as tables, such as by interfacing with the second computing environment in order to expose a user interface.

Certain embodiments provide that the configuration component comprises a specified format for displaying data. Specified formats for displaying data generally include any arrangements for displaying data within a user interface. For example, the specified format may include specifications regarding the number of rows and/or columns in a table, partition configurations for tables, and/or the like. Certain embodiments provide that the specified format comprises an arrangement of selections from one or more tables.

According to some embodiments, the configuration component comprises a specified schedule for updating the user interface with additional data from the second computing environment. The specified schedule may include a time for extracting data from the second computing environment. For example, the specified schedule may require extracting data from the second computing environment at a given periodicity, such as weekly, daily, hourly, after a given amount of time has elapsed and/or the like.

Certain embodiments provide that the builder component updates the user interface based on changes made to configuration settings. For example, the builder component may check for changes made to the configuration component, and automatically update the user interface based on the changes.

In certain embodiments, the specified schedule may specify whether the additional data should be appended to data previously included in user interface content, or whether the additional data should replace previously included data. Appending additional data to previously included data may comprise adding additional rows and/or columns to a table. For example, a user may want to append additional data to previously included data if the user wants to track changes in data over time. Replacing previously included data with additional data may comprise overwriting the previously included data with the additional data in a table. As an example, a user may want to replace previously included data with the additional data in order to have a table with continuously updated values.

Some embodiments provide that the specified schedule comprises a location for inserting the additional data. For example, the location for appending additional data may be a given table, and the location for replacing previously included data may be a particular row within the table. In some embodiments, the specified schedule comprises an indication of the additional data to be included within the user interface, such as an indication of the location of the additional data, as discussed above.

According to certain embodiments, users may provide configuration component templates to the first computing environment. Configuration component templates may be structured lists that allow users to specify which data the builder component should include within the user interface, the format for displaying the data, the schedule for updating the user interface with additional data, and/or the like. For example, a user may populate a configuration component template by selecting from options included in the template (e.g., selecting a configuration of a set of available configurations for displaying data) or adding data to the template (e.g., specifying a location within the second computing environment that contains the data). In some embodiments, configuration component templates are automatically populated by a component within the first computing environment based on inputs provided by users. For example, the user interface may prompt the user to specify a format for displaying data, and the first computing environment may be configured to populate a configuration component template based on the user's response. Some embodiments provide that the populated configuration component template is automatically provided to the builder component by a component within the first computing environment.

According to some embodiments, the builder component may be a computing component such as a script. The builder component may be configured to take a configuration file provided via the first computing environment and construct a user interface within the second computing environment, thus providing an interface between the two computing environments. The builder component may be executed in response to the creation of a configuration component. Based on an indication of data to be to be included in the user interface, the builder component may build a user interface comprising user interface content within the second computing environment. For example, a function within the builder component may submit a call to the second computing environment that indicates the data to be included in the user interface and indicates a format for displaying data in a user interface. Based on these indications, a user interface may be constructed in the second computing environment.

Certain embodiments provide that the builder component builds user interface content based on the format specified by the configuration component for displaying data, as described above. For example, the user interface content may be a table having dimensions that are specified by the configuration component. The builder component may build the user interface content within the second computing environment, resulting in a custom user interface for the second computing environment.

Some embodiments provide that the builder component may update the user interface with additional data based on the specified schedule. For example, the builder component may append the additional data to data that was previously added to the user interface, or the builder component may replace previously added data with the additional data, as discussed above. Appending data to previously added data may comprise inserting data into a particular table or other location as specified by the configuration component. Replacing previously added data may comprise overwriting data contained within a table or other location as specified by the configuration component. Once the additional data is appended to or used to replace data within the user interface, an updated user interface is created. In some embodiments, the updated user interface is displayed via a display associated with a computing device.

According to certain embodiments, when the user provides an indication to stop updating a user content item within the user interface, the builder component ceases to update the user interface content item according to the specified schedule. In some embodiments, the user interface content item may be altered to indicate that updates for the item have ceased. For example, the user may want to preserve data within a user interface content item such as a table as-is. The user may provide an indication for the builder component to stop making additional updates to the table, and the builder component may stop making calls to the second computing environment to update the table. The builder component may also modify the table to indicate that updates have been ceased. For example, the table may be modified to show the last date and time on which the table was updated.

Embodiments of the present disclosure provide numerous technical and practical effects and benefits. For instance, embodiments of the present disclosure allow users to specify configurations for viewing data through a first computing environment and view the data through a second computing environment, even when the two environments are not natively compatible. As discussed earlier, existing technologies do not allow for user interface interoperability between two otherwise incompatible computing environments. By giving users the flexibility to perform data query tasks using a first computing environment and view data through a second computing environment that is otherwise incompatible with the first computing environment, teachings of the present disclosure ensure that the users are able utilize the features of those respective computing environments, such as particular formats for displaying data that are not available in other computing environments, or particular features involving the entering of user interface specifications. For example, teaching of the present disclosure allow users who operate an automated workflow within the first computing environment to seamlessly modify user interfaces within the second computing environment via the workflow. Allowing users to perform such tasks and access data through their preferred computing environments also allows for greater convenience to users, since users will not be forced to rely on other computing environments for submitting configuration specifications or viewing data.

### Example Computing Components Related to Generating Custom User Interfaces

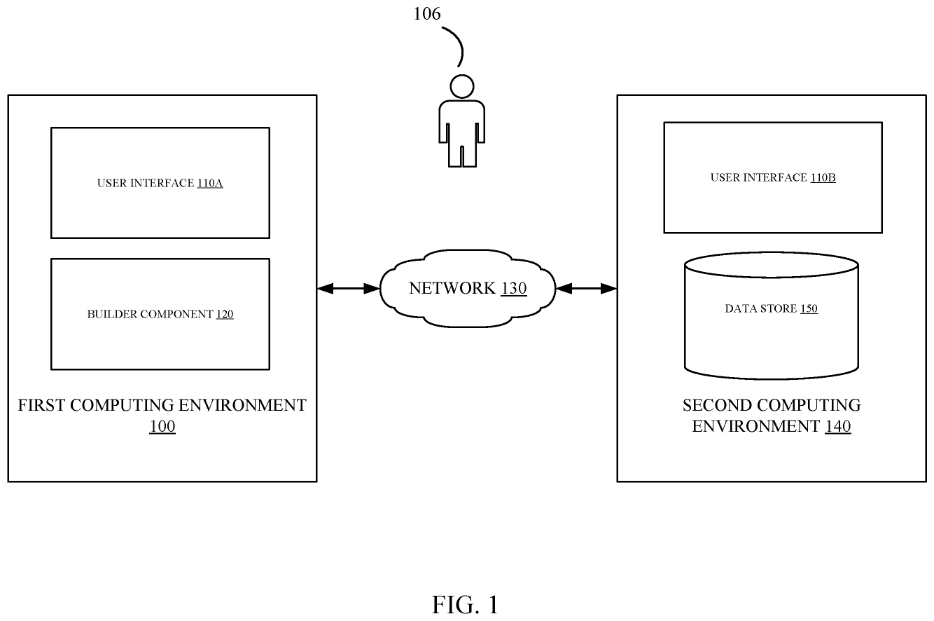

FIG. 1 is an illustration of example computing components related to generating custom user interfaces.

First computing environment 100 may be a computing environment corresponding to a software application used by a user 106. The software application of the first computing environment 100 may be, for example, a cloud service platform such as CloudFormation® from Amazon Web Services® (AWS). The software application of the first computing environment 100 may allow users to manage data received over a network 130, such as a cloud computing network.

First computing environment 100 may include a computing device that allows user 106 to interact with first computing environment 100 via a user interface 110A.

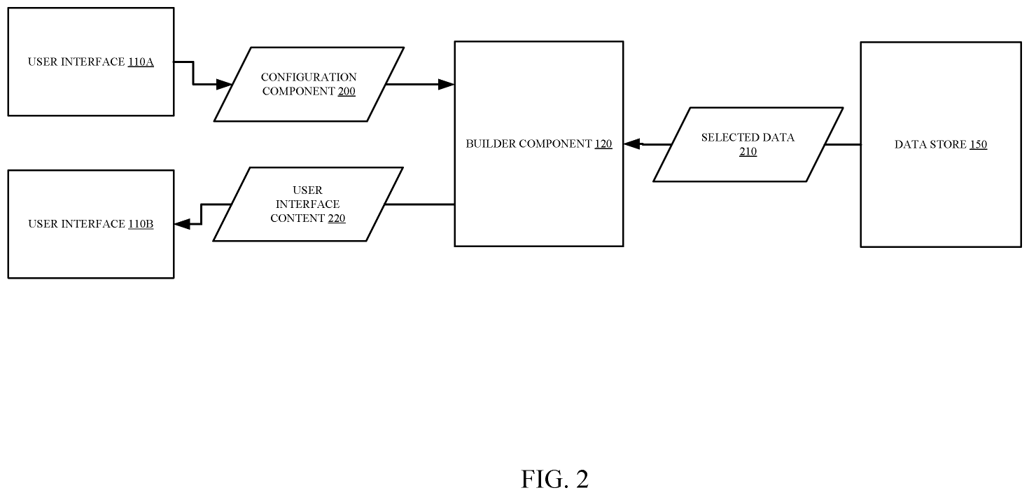

First computing environment 100 may include a builder component 120 that builds user interface content for user interface 110B, as discussed in further detail below with respect to FIG. 2.

First computing environment 100 may interact with a second computing environment 140 over network 130. Network 130 may be any connection over which data may be transmitted. In one example, network 130 is the Internet. Second computing environment 140 may include data store 150 that stores data. For example, the software application of the second computing environment 140 may be a cloud storage platform such as Google® BigQuery®. Data store 150 may be a data storage entity associated with the software application of the second computing environment 140. First computing environment 100 may not be natively configured to build a user interface within second computing environment 140. For instance, first computing environment 100 and second computing environment 140 may be based on different programming languages that are not configured to share data with one another. Builder component 120 may be configured to provide an interface between first computing environment 100 and second computing environment 140. First computing environment 100 may interact with second computing environment 140 by using builder component 120 to construct a user interface within second computing environment 140, as discussed in further detail below with respect to FIG. 2.

### Example Computing Components Related to Generating Custom User Interfaces

FIG. 2 is an illustration of example computing components related to generating custom user interfaces.

User interface 110A may be a user interface associated with the first computing environment, as discussed above with respect to FIG. 1. User interface 110A may allow for providing a configuration component 200 to builder component 120 based on input from a user. The user input may include, for example, an indication of data within the data store 150 of the second computing environment that the user wants to include in user interface 110B. As another example, the user input may include an indication of a format in which the user wants the data to be displayed. As an additional example, the user input may include a schedule for updating user interface 110B with additional data from the data store 150 (e.g., the user input may include instructions to update at a given periodicity, such as once every day or once every week). The user input may be provided as an answer to a prompt provided to the user via the user interface 110. The user input may also be provided by the user without a prompt. In some embodiments, the user input comprises a user completing a template by selecting options within the template and/or inserting information into the template. The configuration component 200 may contain the user input, and the builder component 120 may perform tasks based on the user input. Some embodiments provide that the configuration component 200 is a template that a user has populated, or a template that has been automatically populated based on user input.

Indications of data that the user wants to include within user interface 110B may include indications that allow the builder component 120 to extract the data from the data store 150. For example, the indication may be the name of a location that stores the data, a reference to the data that the builder component 120 is configured to process, and/or the like. Specific functions and/or nodes within builder component 120 may be connected to or otherwise reference locations within the data store 150 that store data. The configuration component 200 may reference a function within builder component 120, causing the function or node to submit a call to the second computing environment to select data for inclusion in a user interface 110B and generate user interface content that includes the data. The user interface 110B that has been updated with the generated user interface content may be displayed to one or more users of a computing device.

Indications of a format in which the user wants the indicated data 210 to be displayed may include an indication that the user wants the data 210 to be displayed in a table or any other format in which the second user environment is capable of displaying data. For example, the second user environment may be configured to display data in tables of a particular type. Based on an indication that the user wants to display the data in a table of the particular type, the builder component may build a table of the particular type and populate it with the extracted data 210. The indication may also indicate other features for the table, such as number of rows, number of columns, size, partitions, and/or the like.

The schedule for updating user interface 110B with additional data from data store 150 may include a specified periodicity for adding additional data. For example, the schedule may require extracting data from data store 150 at a given time interval such as once per day, twice per day, once per week, or any other periodicity.

Builder component 120 may be a computing component such as a script, function, or any other coding artifact capable of submitting calls in order to select data from data store 150 and build user interface content 220 based on the selected data 210 in order to create an updated user interface 110B. Builder component 120 may submit calls to the second computing environment based on indications provided by users of data that the users want to include within user interface 110B, as discussed above. Builder component 120 may extract additional data from data store 150 based on schedules specified by users for extracting additional data, discussed above. Builder component 120 may use the extracted data 210 (including the additional data in some embodiments) to build user interface content 220 (such as tables that include the data) based on formats specified by users for extracting additional data, discussed above. Builder component 120 may provide the user interface content 220 to a user interface 110B in order to create an updated user interface 110B.

In some embodiments, users may want to stop updates to user interface content 220. As a result, a user may provide an indication that the user wants updates to user interface content 220 to cease. Based on this indication, builder component 120 may cease to update the user interface content 220 according to the specified schedule. In some embodiments, the user interface content 220 may be altered to indicate that updates for the user interface content 220 have ceased. For example, the user interface content 220 may be modified to show the last date and time on which the user interface content 220 was updated (such as by modifying descriptions, labels, or other metadata associated with the user interface content 220).

### Example Operations Related to Dynamic Prompt Generation

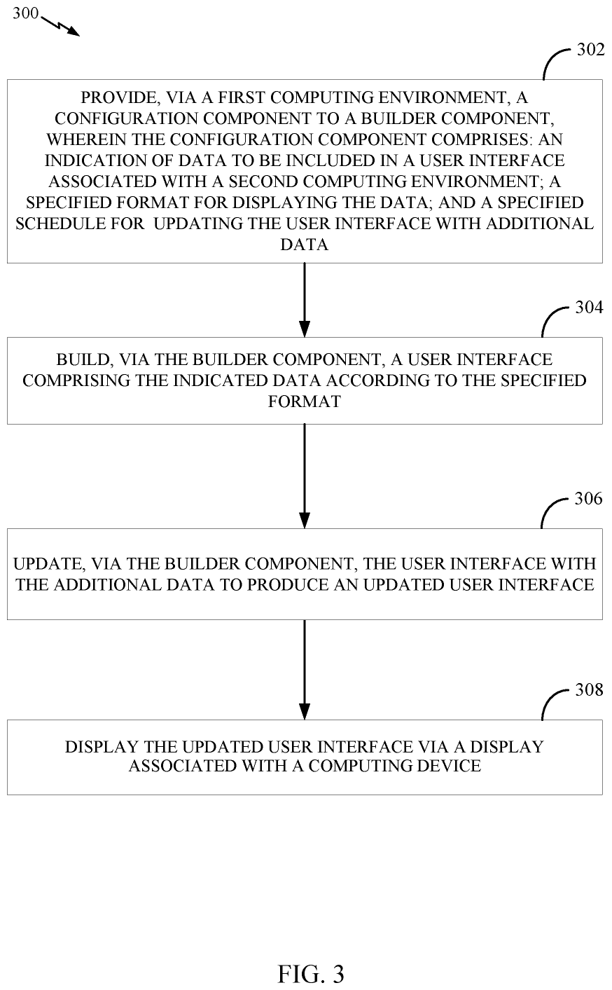

FIG. 3 depicts example operations 300 related to generating custom user interfaces. For example, operations 300 may be performed by one or more of the components described with respect to FIG. 1 or FIG. 2.

Operations 300 begin at step 302 with providing, via a first computing environment, a configuration component to a builder component, wherein the configuration component comprises: an indication of data to be included in a user interface associated with a second computing environment; a specified format for displaying the data; and a specified schedule for updating the user interface with additional data. Certain embodiments provide that the specified format comprises a table. According to certain embodiments, the first computing environment is based on a first programming language, the second computing environment is based on a second programming language, and the builder is configured to serve as an interface between the first computing environment and the second computing environment. In some embodiments, the specified format comprises a format associated with the first computing environment. Some embodiments provide that the specified schedule indicates a periodicity at which updates are made.

Operations 300 continue at step 304 with building, via the builder component, a user interface comprising the indicated data according to the specified format. In some embodiments, the user interface comprises selections from one or more tables.

Operations 300 continue at step 306 with updating, via the builder component, the user interface with the additional data to produce an updated user interface. According to some embodiments, updating the user interface with the additional data comprises replacing particular data within the user interface with the additional data based on the specified schedule. Certain embodiments provide that the builder component updates the user interface based on detecting a change in the configuration component.

Operations 300 continue at step 308 with displaying the updated user interface via a display associated with a computing device.

### Example of a Processing System for Generating Custom User Interfaces

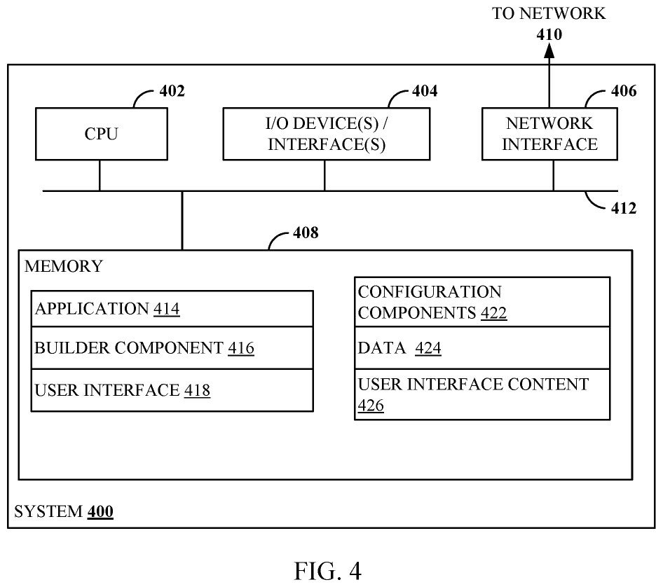

FIG. 4 illustrates an example system 400 with which embodiments of the present disclosure may be implemented. For example, system 400 may be configured to perform operations 300 of FIG. 3 and/or to implement one or more components as in FIG. 1 or FIG. 2.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes application 414, builder component 416, and user interface 418. In some embodiments, application 414 may be representative of a software application associated with first computing environment 100 of FIG. 1. Builder component 416 may be representative of builder component 120 of FIG. 1 and FIG. 2. User interface 418 may be user interface 110 of FIG. 1 and FIG. 2.

Memory 408 further comprises configuration components 422 which may correspond to configuration component 200 of FIG. 2. Memory 408 further comprises data 424, which may correspond to user query 103 of FIG. 1. Memory 408 further comprises generated prompts 426, which may correspond to extracted data 210 of FIG. 2. Memory 408 further comprises user interface content 428, which may correspond to user interface content 220 of FIG. 2.

It is noted that in some embodiments, system 400 may interact with one or more external components, such as via network 410, in order to retrieve data and/or perform operations.

### ADDITIONAL CONSIDERATIONS

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for generating a custom user interface, comprising:
providing, via a first computing environment, a configuration component to a builder component, wherein the configuration component comprises:
an indication of data to be included in a user interface associated with a second computing environment;
a specified format for displaying the data; and
a specified schedule for updating the user interface with additional data;
building, via the builder component, a user interface comprising the indicated data according to the specified format;
updating, via the builder component, the user interface with the additional data to produce an updated user interface; and
displaying the updated user interface via a display associated with a computing device.

2. The method of claim 1, wherein updating the user interface with the additional data comprises replacing particular data within the user interface with the additional data based on the specified schedule.

3. The method of claim 1, wherein the specified format comprises a table.

4. The method of claim 3, wherein the user interface comprises selections from one or more tables.

5. The method of claim 1, wherein, upon receiving an indication from a user to stop updating a user interface content item within the user interface, the builder component ceases updating the user interface content item according to the specified schedule and modifies the user interface content item to indicate that updates have been ceased.

6. The method of claim 1, wherein the first computing environment is based on a first programming language, the second computing environment is based on a second programming language, and the builder component is configured to serve as an interface between the first computing environment and the second computing environment.

7. The method of claim 1, wherein the specified format comprises a format associated with the first computing environment.

8. The method of claim 1, wherein the specified schedule indicates a periodicity at which updates are made.

9. The method of claim 1, wherein the builder component updates the user interface based on detecting a change in the configuration component.

10. A system for generating a custom user interface, comprising:
one or more processors; and
a memory comprising instructions that, when executed by the one or more processors, cause the system to:
provide, via a first computing environment, a configuration component to a builder component, wherein the configuration component comprises:
an indication of data to be included in a user interface associated with a second computing environment;
a specified format for displaying the data; and
a specified schedule for updating the user interface with additional data;
build, via the builder component, a user interface comprising the indicated data according to the specified format;
update, via the builder component, the user interface with the additional data to produce an updated user interface; and
display the updated user interface via a display associated with a computing device.

11. The system of claim 10, wherein updating the user interface with the additional data comprises replacing particular data within the user interface with the additional data based on the specified schedule.

12. The system of claim 10, wherein the specified format comprises a table.

13. The system of claim 12, wherein the user interface comprises selections from one or more tables.

14. The system of claim 10, wherein, upon receiving an indication from a user to stop updating a user interface content item, the builder component ceases updating the user interface content item according to the specified schedule and modifies the user interface content item to indicate that updates have been ceased.

15. The system of claim 10, wherein the first computing environment is based on a first programming language, the second computing environment is based on a second programming language, and the builder component is configured to serve as an interface between the first computing environment and the second computing environment.

16. The system of claim 10, wherein the specified format comprises a format associated with the first computing environment.

17. The system of claim 10, wherein the specified schedule indicates a periodicity at which updates are made.

18. The system of claim 10, wherein the builder component updates the user interface based on detecting a change in the configuration component.

19. A non-transitory computer readable medium comprising instructions that, when executed by one or more processors of a computing system, cause the computing system to:
provide, via a first computing environment, a configuration component to a builder component, wherein the configuration component comprises:
an indication of data to be included in a user interface associated with a second computing environment;
a specified format for displaying the data; and
a specified schedule for updating the user interface with additional data;
build, via the builder component, a user interface comprising the indicated data according to the specified format;
update, via the builder component, the user interface with the additional data to produce an updated user interface; and
display the updated user interface via a display associated with a computing device.

20. The non-transitory computer readable medium of claim 19, wherein updating the user interface with the additional data comprises replacing particular data within the user interface with the additional data based on the specified schedule.
